(19) United States
(12) Patent Application Publication
(10) Pub. No.: US 2025/0238892 A1
(43) Pub. Date: Jul. 24, 2025

(54) GENERATING DEVICE FOR TIRE FOOTPRINT IMAGE

(71) Applicant: TOYOTA JIDOSHA KABUSHIKI KAISHA, Toyota-shi (JP)

(72) Inventor: Guangxin SHAO, Toyota-shi (JP)

(73) Assignee: TOYOTA JIDOSHA KABUSHIKI KAISHA, Toyota-shi (JP)

(21) Appl. No.: 18/908,812

(22) Filed: Oct. 8, 2024

(30) Foreign Application Priority Data
Jan. 18, 2024 (JP) 2024-005741

(51) Int. Cl. G06T 3/073; G06T 7/68; G06V 10/25; G06V 20/64

(52) U.S. Cl. CPC G06T 3/073; G06T 7/68; G06V 10/25; G06V 20/64

(57) ABSTRACT

A CPU (processor) executes a processing process, a setting process, and an extraction process. In the processing process, CPU processes the planar tread surface image from the exterior image of the tire including the curved tread surface. In the setting process, CPU obtains an extraction range of the planar tread surface image. In the extraction process, CPU extracts part of the planar tread surface images based on the extraction range. The extracted image is output as a footprint image. In addition, in the setting process, CPU determines the contact patch width and contact patch length of the tire based on the specification data of the tire and the vehicle weight data. Further, in the setting process, CPU determines the extraction range based on the contact patch width and the contact patch length.

### CROSS-REFERENCE TO RELATED APPLICATION

This application claims priority to Japanese Patent Application No. 2024-005741 filed on Jan. 18, 2024, incorporated herein by reference in its entirety.

### BACKGROUND

### 1. Technical Field

The present specification discloses generating devices for a tire footprint image.

### 2. Description of Related Art

In Japanese Unexamined Patent Application Publication No. 2007-237751 (JP 2007-237751 A), a tire is analyzed based on the footprint of the tire. A footprint refers to a contact patch of a tire. Therefore, a footprint image is an image of the contact patch of a tire.

For example, grooves are formed in the tire surface. The grooves of the tire and the road surface form tube structures in the contact patch of the tire. Noise is generated from the tire due to air column resonance that occurs in the column structures. Acquiring a footprint image allows to analyze the tube structures such as tube length.

### SUMMARY

Using a measuring instrument to acquire a footprint makes a work process complicated. For example, a worker installs a tire on a vehicle. The worker then operates the vehicle so that the tire is located on the measuring instrument. The measuring instrument includes a plurality of pressure sensors. Pressure distribution in the contact patch of the tire is obtained by the measuring instrument. This pressure distribution is used as a footprint image.

The present specification discloses a generating device for a tire footprint image that can acquire a tire footprint image more easily and simply than before.

The present specification discloses a generating device for a tire footprint image. The generating device includes a processor. The processor is configured to perform a processing process, a setting process, and an extraction process. In the processing process, the processor processes an exterior image of a tire including a curved tread surface into a planar tread surface image. In the setting process, the processor determines an extraction range of the planar tread surface image. In the extraction process, the processor extracts part of the planar tread surface image based on the extraction range. The processor outputs the extracted part of the planar tread surface image as a footprint image. In the setting process, the processor determines a contact patch width of the tire and a contact patch length of the tire based on specification data of the tire and vehicle weight data. In the setting process, the processor determines the extraction range based on the contact patch width and the contact patch length.

With the above configuration, the footprint image is generated using the exterior image of the tire, the specification data of the tire, and the weight data of a vehicle on which the tire is mounted as input data.

In the above configuration, the processor may be configured to perform the following processing in the processing process. The processor obtains a center line of the exterior image of the tire. The processor then divides the exterior image of the tire using the center line as a dividing line. Thereafter, the processor performs a projective transformation on each of divided images. The processor then combines the divided images after the projective transformation to generate the planar tread surface image.

With the above configuration, the curved tread surface image is converted into the planar tread surface image. That is, the same image as that of a tread surface in a contact patch can be generated by the projective transformation.

In the above configuration, the processor may be configured to perform the following processing in the setting process. The processor generates an extraction frame based on the contact patch width and the contact patch length. The processor then rounds the extraction frame.

With the above configuration, an image closer to an actual footprint image can be generated.

In the above configuration, the processor may be configured to set a vertex for the projective transformation when performing the projective transformation. When setting the vertex, the processor may set a corresponding point on a tangent line to a boundary edge of the curved tread surface included in the divided image before the projective transformation.

With the above configuration, the projective transformation according to the curved tread surface can be performed.

In the above configuration, the processor may be equipped with a contact patch length neural network and a contact patch width neural network. The contact patch length neural network uses the specification data of the tire and the vehicle weight data as an input layer, and uses the contact patch length as an output layer. The contact patch width neural network uses the specification data of the tire and the vehicle weight data as an input layer, and uses the contact patch width as an output layer.

With the above configuration, the contact patch length neural network and the contact patch width neural network can be trained to learn using conventionally accumulated data related to footprint images as training data.

The generating device for a tire footprint image disclosed in the present specification can acquire a tire footprint image more easily and simply than before.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a hardware configuration of a generating device for a footprint image;

FIG. 2 is a diagram illustrating functional blocks of a generating device for a footprint image;

FIG. 3 is a flowchart illustrating a footprint image generation process;

FIG. 4 is a diagram illustrating an appearance photograph of a tire;

FIG. 5 is a diagram illustrating an example in which a background is deleted from an appearance photograph of a tire;

FIG. 6 is a diagram illustrating an example of binarization of the image of FIG. 7;

FIG. 7 illustrates a process for determining the center of a binarized exterior image;

FIG. 8 is a diagram illustrating an example of dividing a binarized image;

FIG. 9 is a diagram illustrating a process of performing a projective transformation on a divided image;

FIG. 10 is a diagram illustrating an example of combining divided images after projective transformation;

FIG. 11 is a diagram illustrating a contact patch length CNN;

FIG. 12 is a diagram illustrating a contact patch width CNN;

FIG. 13 is a view for explaining an extraction range of a tread surface image on the plane of FIG. 10;

FIG. 14 is a diagram illustrating a tread plane image extracted by an extraction frame;

FIG. 15 is a diagram illustrating an exemplary case in which a rectangular frame is rounded; and

FIG. 16 is a diagram illustrating a generated footprint image.

### DETAILED DESCRIPTION OF EMBODIMENTS

### 1. Hardware Configuration

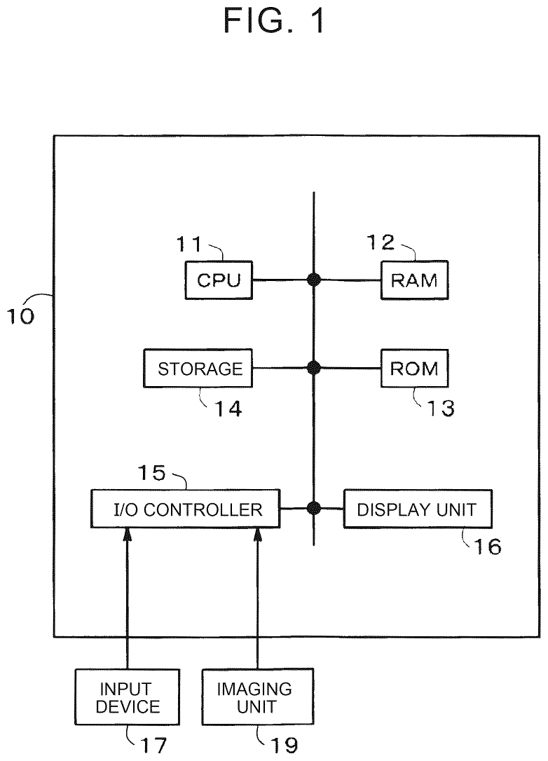

A generating device 10 for a footprint image of a tire according to this embodiment is illustrated in FIG. 1. In the following description, the generating device 10 for tire footprint image is referred to as an “image generating device 10” as appropriate.

The image generating device 10 includes, for example, a computer. The image generating device 10 includes a CPU 11, RAM 12, ROM 13, a storage 14, an input/output controller 15, and a display unit 16.

CPU 11 is a central processing unit, also referred to as a processor. A RAM 12 is a volatile storage device that temporarily stores data that is in operation. ROM 13 is a data-readable storage device. The storage 14 is a storage device capable of writing and reading data. The storage 14 is composed of, for example, a Hard Disk Drive (HDD) or a Solid State Drive (SSD).

### 2. Function Block

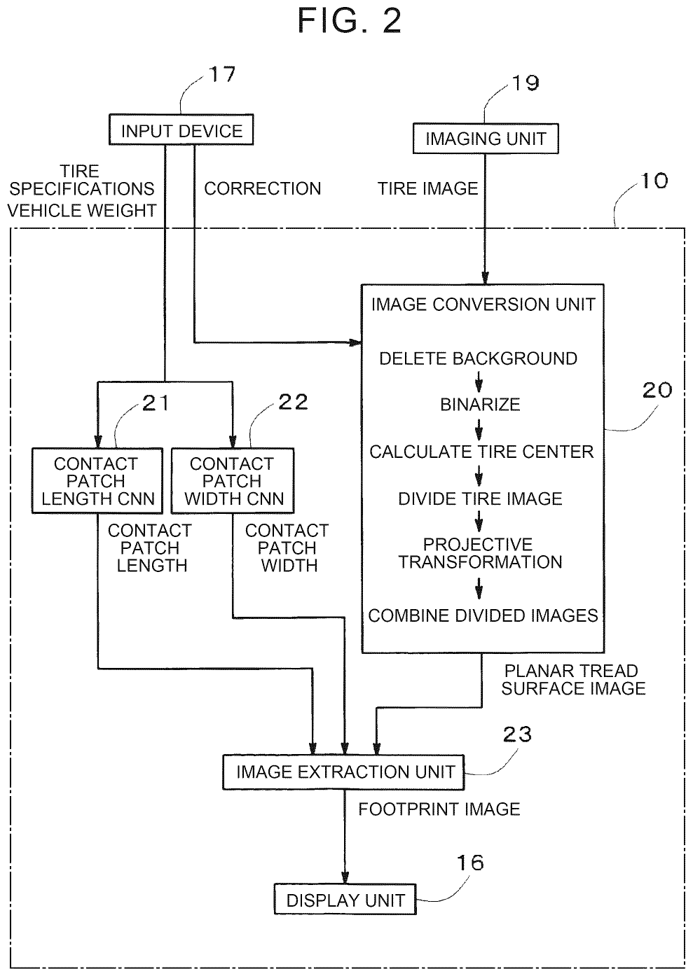

When CPU 11 (processor) executes the program stored in ROM 13 or the storage 14, the image generating device 10 includes a functional unit as illustrated in FIG. 2. That is, the image generating device 10 includes the image processing unit 20, the contact patch length CNN 21, the contact patch width CNN 22, and the image extracting unit 23 as functional units. In other words, these functional units are implemented in CPU 11. That is, CPU 11 can execute the process by the above-described functional unit. The details of the processing performed by the functional unit will be described later.

Data is input to the image generating device 10 from the input device 17 and the image capturing device 19. The input device 17 is, for example, a keyboard. Further, as will be described later, the exterior image data of the tire is input from the image capturing device 19 to the image generating device 10.

### 3. Footprint Image Generation Process

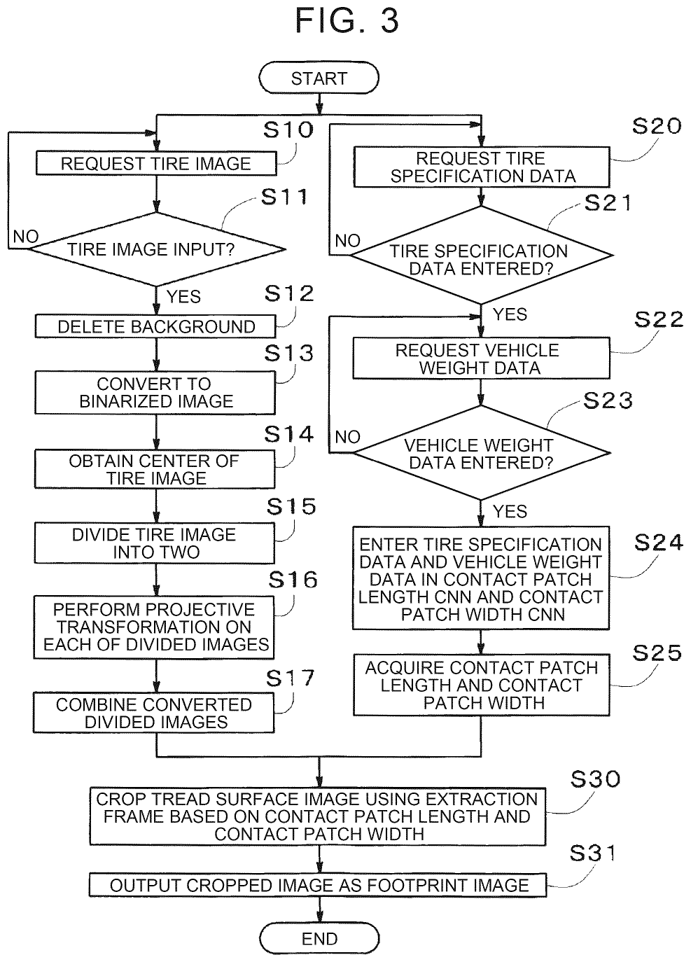

FIG. 3 illustrates a flow of generating a footprint image. This generation flow is executed by the image generating device 10. This production flow is branched into two processes. That is, the generation process is branched into a processing process (S10 to S17) and a setting process (S20 to S25). The processing process and the setting process are combined at a later stage. Further, the generation process executes an extraction process (S30, S31).

In the processing process, the curved tread surface image is processed into a planar shape. In the setting process, an extraction range of the planar tread surface image is obtained. Further, in the extraction processing, a part of the planar tread surface image is extracted based on the extraction range. The extracted image is output as a footprint image.

### 3-1. Planarization of Tread Surface Image (Processing Process)

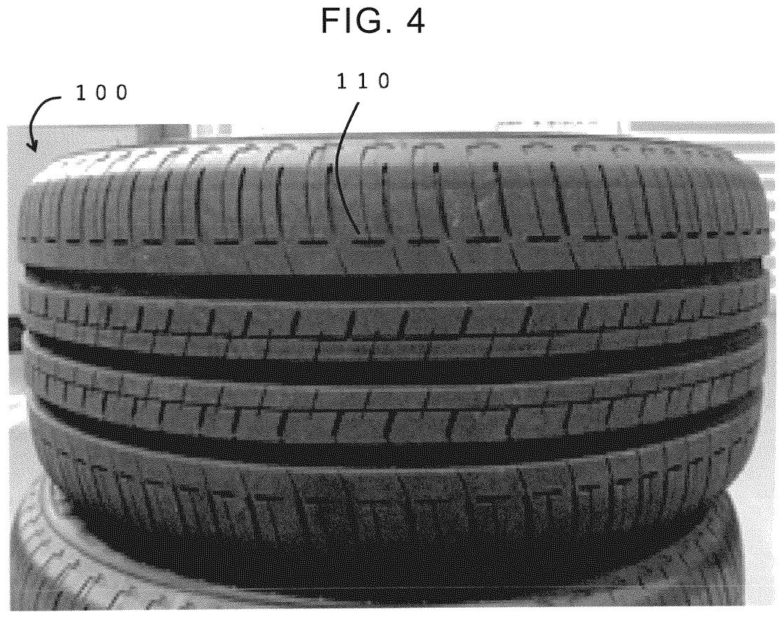

Referring to FIG. 2, an exterior image of a tire is input from the image capturing device 19 to the image generating device 10. FIG. 4 exemplifies an exterior image of the tire 100 captured by the image capturing device 19. The exterior image includes a curved tread surface 110. That is, the tread surface 110 in the non-grounded state is included in the captured image.

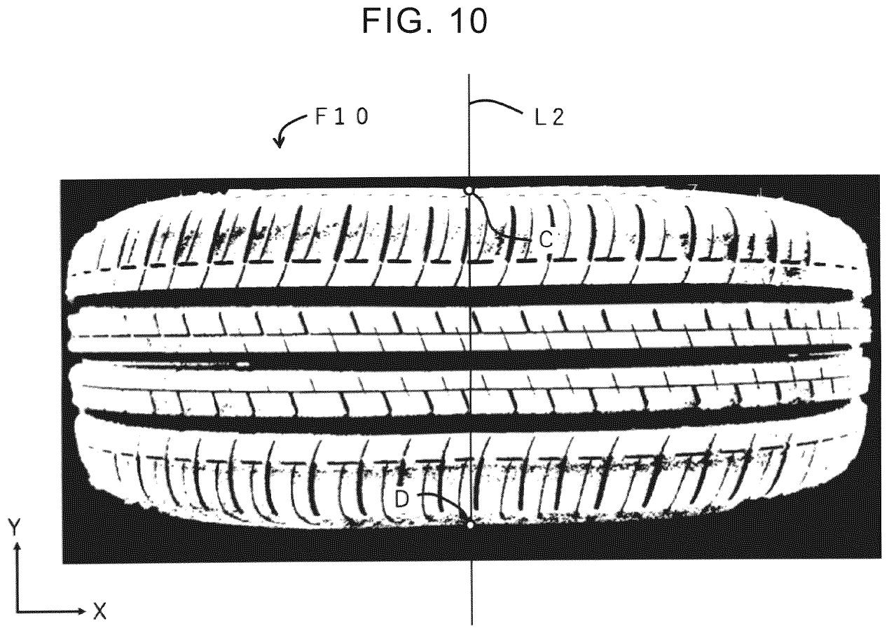

The appearance of the tire 100 is imaged in a state where no pressure is applied to the tread surface 110. For example, as shown in FIG. 4, the tire 100 is imaged while lying down. As illustrated in FIG. 4, the exterior image of the tire 100 is expressed in an arc shape in the contour from the center in the longitudinal direction toward both ends. The image generating device 10 processes the image of the curved tread surface 110 into a planar image (see FIG. 10).

Referring to FIGS. 2 and 3, the image processing unit 20 requests an exterior image of the tire 100 (S10). For example, the image processing unit 20 displays an image request message on the display unit 16. Further, the image processing unit 20 confirms whether an exterior image of the tire 100 is inputted (S11). If the picture is not entered, it returns to S10.

When the exterior image of the tire 100 is inputted, the image processing unit 20 deletes the background from the image (S12). For example, the background images are deleted using a Grub Cut Algorithm.

The grab cut algorithm is a known image processing technique. Therefore, the Grub Cut Algorithm will be briefly described below. First, a foreground region is designated from an exterior image (see FIG. 4) of the tire 100. For example, an operator of the input device 17 designates a foreground region. In the present embodiment, the foreground region is an image region of the tire 100. Then, the image processing unit 20 divides the forward tilt region and the background region based on the designation of the foreground region.

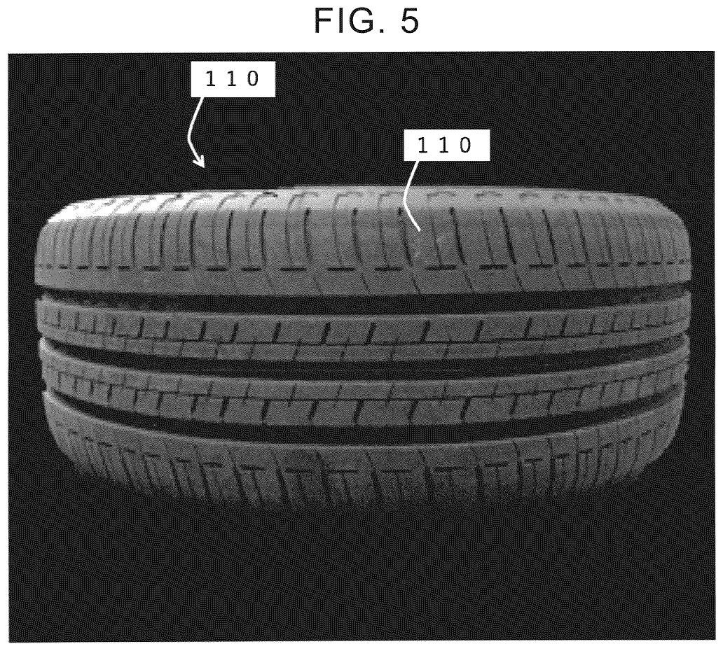

The foreground image after the division processing is displayed on the display unit 16. An operator of the input device 17 confirms the displayed image. When the foreground is included in the background, or when the background is included in the foreground, the input device 17 designates the background region in the forward tilting state and the foreground region in the background. By repeating such interactive extraction processing, the background is deleted from the image of FIG. 4. The tire images of S12 deletion process are illustrated in FIG. 5.

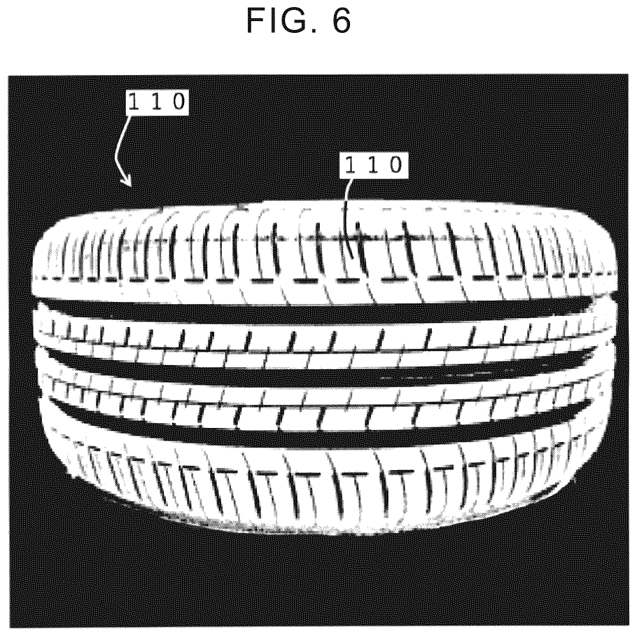

Next, the image processing unit 20 binarizes the tire image of FIG. 5 (S13). In the binarization process, the pixel values of the pixels on the tire image are divided into either 0 (black) or 255 (white). FIG. 6 illustrates a binarized tire image. For example, the tire image is binarized by adaptive binarization. Adaptive binarization is a known binarization technique. Therefore, the processing by adaptive binarization will be briefly described below.

In adaptive binarization, the average value of the converted pixel and its neighboring pixel becomes a threshold value of binarization. For example, it is assumed that a certain pixel (pixel A1) and another pixel (pixel A2) have the same pixel value (e.g., 120). If the mean of the pixel A1 and the pixel values of its surrounding pixels is lower than the pixel A1 (e.g., 100), then the pixel A1 is converted to white (120 to 255). When the mean value of the pixel values of the pixel A2 and the neighboring pixels is higher than the pixel A2 (for example, 140), the pixel A2 is converted into black (0 to 120). In this way, the threshold value for binarization is adaptively set according to the ambient brightness or the like. By binarizing the tire image, the following geometric calculation can be performed with high accuracy.

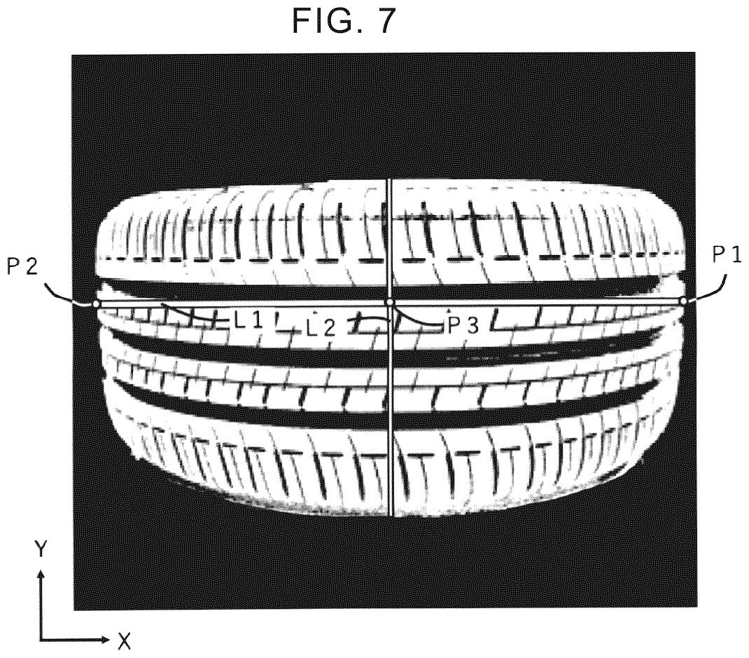

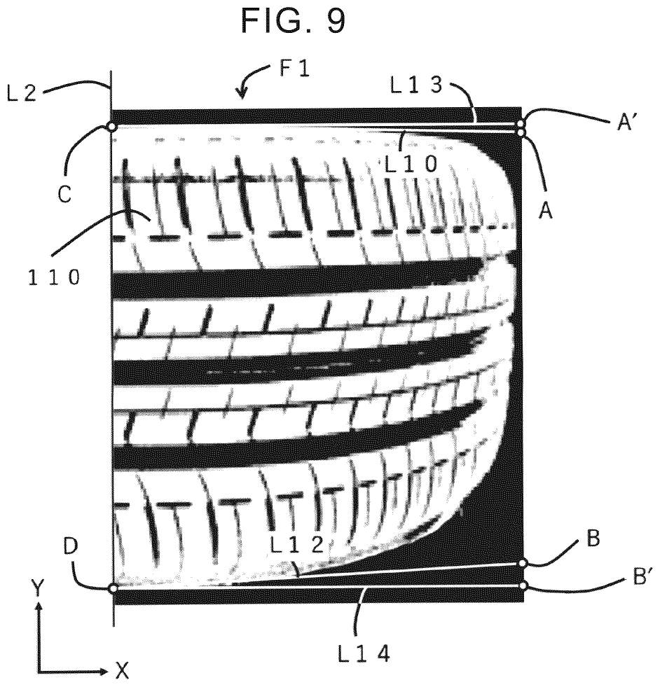

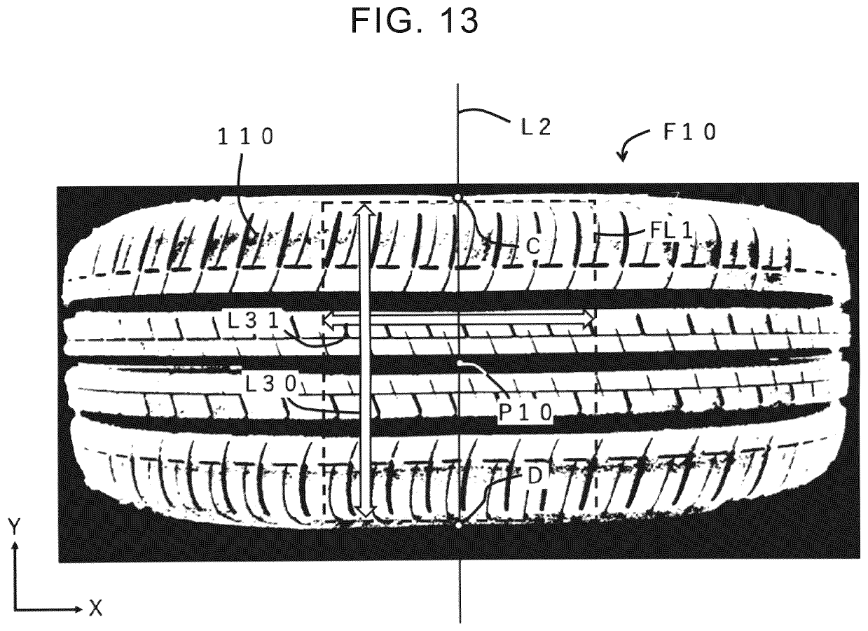

The image processing unit 20 obtains the center line of the binarized tire image (S14). In FIG. 7, FIG. 9, FIG. 10, and FIG. 13 to FIG. 16, a X-Y coordinate system is used as a coordinate system of images. The X-axis and the Y-axis are orthogonal.

Referring to FIG. 7, for example, the image processing unit 20 obtains an end point P1 on the longitudinal axis (X axis) of the binarized image of the tire 100. For example, the image processing unit 20 extracts a pixel having the largest value of the X-axis coordinate from among pixels having a pixel value of 255 (white), and sets the pixel as an end point P1. Similarly, the image processing unit 20 extracts a pixel having the smallest value in the X-axis coordinate from pixels having a pixel value of 255 (white), and sets the pixel as an end point P2.

Further, the image processing unit 20 obtains the center point P3 of the straight line L1 connecting the end points P1, P2. Next, the image processing unit 20 obtains a normal to the straight line L1 from the center point P3. This perpendicular becomes the center line L2.

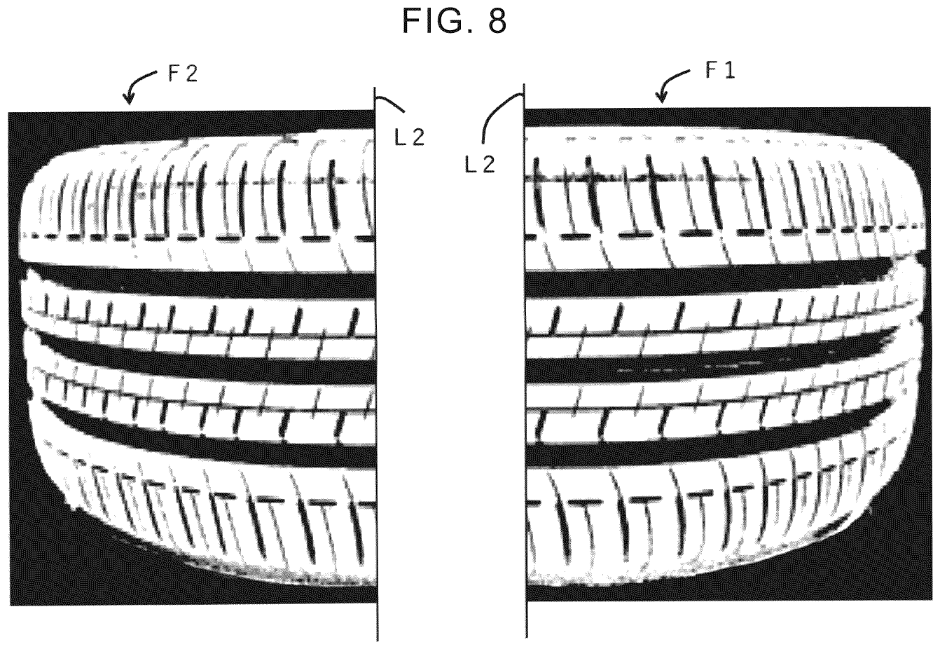

Referring to FIG. 8, next, the image processing unit 20 divides the exterior image of the tire into image F1, F2 using the center line L2 as a dividing line (boundary line) (S15). Next, the image processing unit 20 performs projective transformation on each of the divided image F1, F2 (S16).

FIG. 9 shows an exemplary projective transformation for a divided image F1, projective transformations are also referred to as homography transformation. In the projective transformation, a transformation from a square to another square is performed. For example, a trapezoidal to rectangular conversion is performed.

In a homography transform, four vertex coordinates (x11,y11), (x12,y12), (x13,y13), (x14,y14) of a square are moved to (x21,y21), (x22,y22), (x23,y23), and (x24,y24). The motion of this vertex is expressed by the following equation (eq.1):

$$Mathematical formula 1$$

$$( \begin{matrix}{x}_{11} & {y}_{11} & 1 & 0 & 0 & 0 & - {x}_{11} {x}_{21} & - {y}_{11} {y}_{21} \\ 0 & 0 & 0 & {x}_{11} & {y}_{11} & 1 & - {x}_{11} {x}_{21} & - {y}_{11} {y}_{21} \\ {x}_{12} & {y}_{12} & 1 & 0 & 0 & 0 & - {x}_{12} {x}_{22} & - {y}_{12} {y}_{22} \\ 0 & 0 & 0 & {x}_{12} & {y}_{12} & 1 & - {x}_{12} {x}_{22} & - {y}_{12} {y}_{22} \\ {x}_{13} & {y}_{13} & 1 & 0 & 0 & 0 & - {x}_{13} {x}_{23} & - {y}_{13} {y}_{23} \\ 0 & 0 & 0 & {x}_{13} & {y}_{13} & 1 & - {x}_{13} {x}_{23} & - {y}_{13} {y}_{23} \\ {x}_{14} & {y}_{14} & 1 & 0 & 0 & 0 & - {x}_{14} {x}_{24} & - {y}_{14} {y}_{24} \\ 0 & 0 & 0 & {x}_{14} & {y}_{14} & 1 & - {x}_{14} {x}_{24} & - {y}_{14} {y}_{24}\end{matrix} ) ( \begin{matrix}{h}_{11} \\ {h}_{12} \\ {h}_{13} \\ {h}_{21} \\ {h}_{22} \\ {h}_{23} \\ {h}_{31} \\ {h}_{32}\end{matrix} ) = ( \begin{matrix}{x}_{21} \\ {y}_{21} \\ {x}_{22} \\ {y}_{22} \\ {x}_{23} \\ {y}_{23} \\ {x}_{24} \\ {y}_{24}\end{matrix} ) \qquad ( eq . 1 )$$

The pre-conversion vertices (x11,y11), (x12,y12), (x13,y13), (x14,y14), and the post-conversion vertices (x21,y21), (x22,y22), (x23,y23), and (x24,y24) are designated in advance by an operator or the like. Thus, equation (eq.1) is an 8-way equation containing the homography parameter h11, h12, h13, h21, h22, h23, h31, h32. In Equation (eq.1), eight mathematical expressions are displayed in a matrix. That is, the homography parameter eq.1 can be calculated by substituting the numerical values of (x11,y11), (x12,y12), (x13,y13), (x14,y14), (x21,y21), (x22,y22), (x23,y23), and (x24,y24) into the mathematical expression (h11, h12, h13, h21, h22, h23, h31, h32).

FIG. 9 illustrates a process for determining four vertices in a projective transformation. The vertex C and the vertex D are set on the center line L2 which is the center of the tire. The image processing unit 20 searches for a pixel having a pixel value of 255 (white) among the pixels on the center line L2. Among these pixels, the image processing unit 20 sets the uppermost point and the lowermost point on the center line L2 to the vertex C, vertex D. The vertex C, vertex D is a fixed point that does not move before and after the projective transformation. That is, the relation (x11,y11)=(x21,y21) holds for the vertex C. For the vertex D, the relation (x12,y12)=(x22,y22) holds.

Next, the image processing unit 20 curve-approximates the boundary edge of the curved tread surface 110 in the divided image F1. In other words, the image processing unit 20 curve-approximates the boundary line between the tread surface 110 and the background. Since the tread surface 110 has a boundary with the background on the upper and lower sides, two approximate curves are obtained.

The two approximation curves intersect the vertex C and the vertex D. The image processing unit 20 obtains the tangent line L10 to the approximate curve at the vertex C. Similarly, the image processing unit 20 obtains the tangent line L12 to the approximate curve at the vertex D. The tangent lines L10, L12 can be referred to as the tangent line to the boundary edge of the tread surface 110. A vertex A and a vertex B are set on the tangent lines L10, L12. For example, the intersection point between the tangent lines L10, L12 and the lateral end of the divided image F1 is the vertex A and the vertex B.

Next, the image processing unit 20 obtains a perpendicular line L13, L14 with respect to the center line L2. Here, the perpendicular line L13, L14 intersects the vertex C and the vertex D. The intersection point between the perpendicular line L13, L14 and the lateral end of the divided image F1 is the vertex A′ and the vertex B′. Further, the image processing unit 20 obtains a homography parameter in which the vertex C and the vertex D are fixed and the vertex A and the vertex B are moved to the vertex A′ and the vertex B′.

As described above, by performing the projective transformation according to the curved surface shape of the tread surface 110, the tread surface 110 can be converted into a planar tread surface with high accuracy.

The projective transformation illustrated in FIG. 9 is also performed on the divided image F2 (see FIG. 8). The image processing unit 20 combines the divided image F1′, F2′ after the projective transformation. In FIG. 10, a planar tread surface image F10, which is an image after combining, is shown.

### 3-2. Determination of Extraction Frame (Setting Process)

Referring to FIG. 2, the CPU 11 of the image generating device 10 may be equipped with a contact patch length CNN 21 (contact patch length neural network) and a contact patch width CNN 22 (contact patch width neural network). CNN is an abbreviation for convolutional neural network (Convolutional Neural Network).

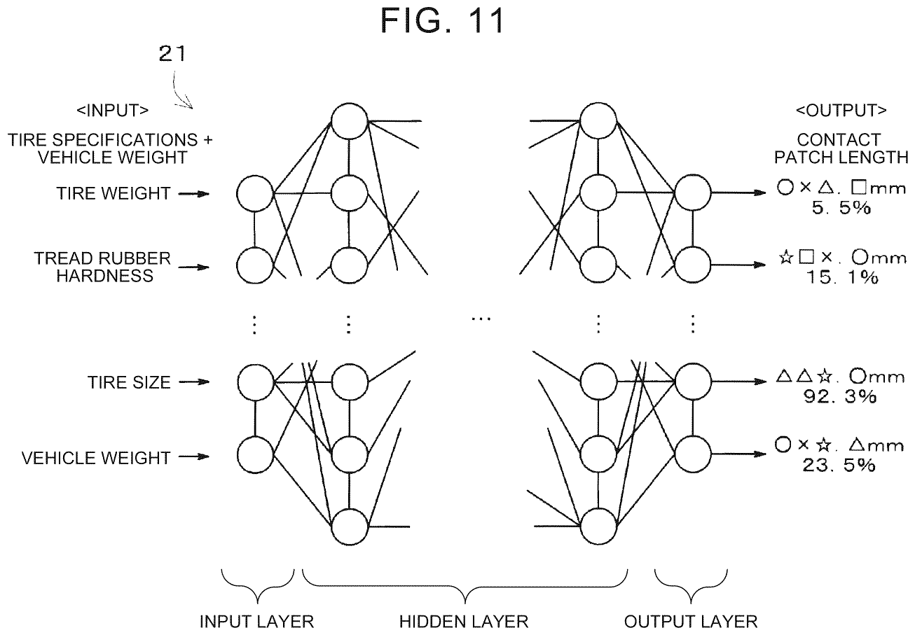

FIG. 11 illustrates a contact patch length CNN 21. The contact patch length CNN 21 comprises an input layer, a hidden layer, and an output layer. A plurality of nodes is provided in each layer.

The specification data of the tire 100 and the weight data of the vehicle are input to the input layer. The specification data includes data such as the size, weight, material, and function of the tire 100. For example, the specification data of the tire 100 includes tire weight, tread rubber hardness, tire size, tire weight, rolling resistance coefficient, tread rubber material, load index, static load radius, flattening ratio, rim diameter, and rim width. The specification data of the tire 100 can be obtained from the supplier of the tire 100.

The weight data of the vehicle can also be obtained from the supplier of the vehicle. As for the weight data of the vehicle, a numerical value obtained by reducing the numerical value at a predetermined ratio may be input instead of inputting the numerical value described in the specification.

A contact patch length of the tire 100 is output from the output layer. The output layer is provided with a plurality of nodes, contact patch length and accuracy are output from each node.

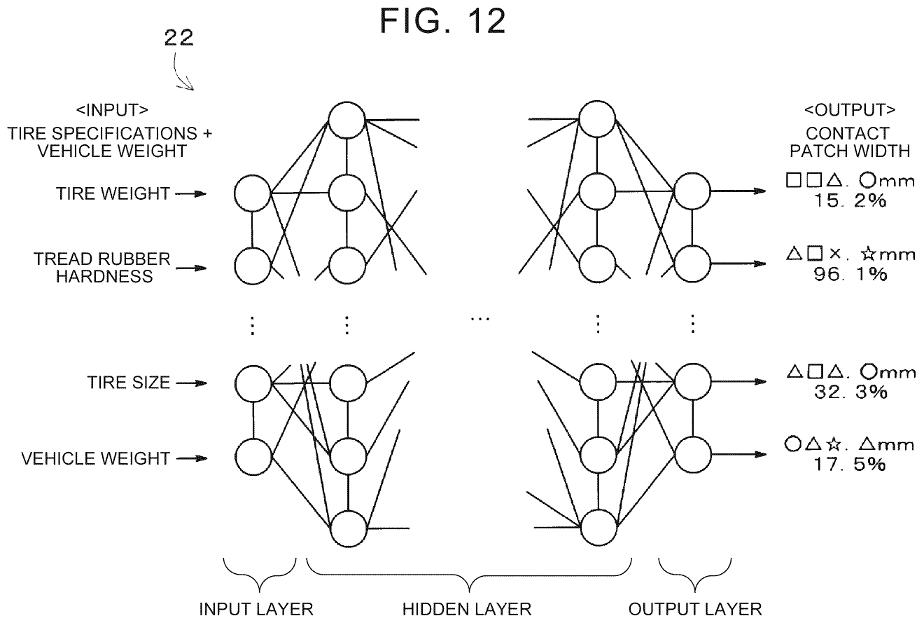

FIG. 12 illustrates a contact patch width CNN 22. Similar to the contact patch length CNN 21, the contact patch width CNN 22 comprises an input layer, a hidden layer, and an output layer. A plurality of nodes is provided in each layer.

Similar to the contact patch length CNN 21, the specification data of the tire 100 and the weight data of the vehicles are input to the input layers in the contact patch width CNN 22. A contact patch width of the tire 100 is output from the output layer. The output layer is provided with a plurality of nodes. Contact patch width and accuracy are output from each node.

In the conventional tire characteristic analysis, the specification data and the vehicle weight of the tire and the contact patch length and the contact patch width are recorded. Therefore, the training data can be generated from the past tire characteristic analysis results. In this training data, the input data is specification data of the tire and the vehicle weight. Further, the correct answer data is a contact patch length and a contact patch width. The CPU 11 (see FIG. 1) of the image generating device 10 is equipped with the learned contact patch length CNN 21 and the contact patch width CNN 22 using such training data.

Referring to FIG. 3, the image generating device 10 requests specification data of the tire 100 (S20). For example, the image generating device 10 displays the specification data request message on the display unit 16 (see FIG. 2). Specification data of the tire 100 is input from the input device 17. Further, the image generating device 10 confirms whether the specification information of the tire 100 is inputted (S21). If the specification is not entered, the flow returns to S20.

When the specification data of the tire 100 is inputted, the image generating device 10 requests the weight data of the vehicle (S22). For example, the image generating device 10 displays a request message for vehicle weight data on the display unit 16. The weight data of the vehicle is input from the input device 17. Further, the image generating device 10 confirms whether the vehicle-weight information is inputted (S23). If the weighing data has not been entered, the flow returns to S22.

When the specification data of the tire 100 and the weight data of the vehicle are input, these data are input to the input layers of the contact patch length CNN 21 and the contact patch width CNN 22 (S24). The image extracting unit 23 acquires the contact patch length and the contact patch width with the highest accuracy from the output layers of the contact patch length CNN 21 and the contact patch width CNN 22 (S25). The extraction range of the image is determined based on the acquired contact patch length and contact patch width.

### 3-3. Extracting Footprint Images (Extraction Processing)

Referring to FIGS. 2 and 13, the image processing unit 20 obtains the distance between the vertex C and the vertex D from the tire size. For example, the tire-size is expressed as “250/45/R18100W”. According to this embodiment, the tire-width is 250 mm. The image processing unit 20 sets the distance between the vertex C and the vertex D to the tire width (for example, CD=250 mm).

The image processing unit 20 determines the size of the extraction frame FL1 based on the tire width. The horizontal dimension (X-axis length) and the vertical dimension (Y-axis length) of the extraction frame FL1 are the contact patch length and the contact patch width obtained by S25. For example, the image processing unit 20 obtains the length (scale) on the image of the contact patch length L31 and the contact patch width L30 when the distance between the vertex C and the vertex D is defined as the tire width.

Still referring to FIG. 13, the image processing unit 20 obtains the center point P10. The center point P10 is the middle point of the vertex C and the vertex D. The image processing unit 20 makes the center of the extraction frame FL1 coincide with the center point P10.

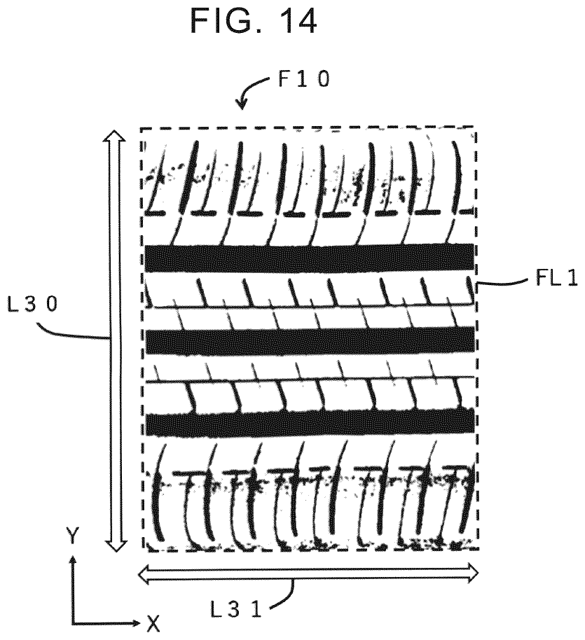

Based on the extraction frame FL1, the image processing unit 20 extracts a part of the planar tread surface image F10 (S30). That is, as illustrated in FIG. 14, the image area in the extraction frame FL1 is extracted from the planar tread surface image F10.

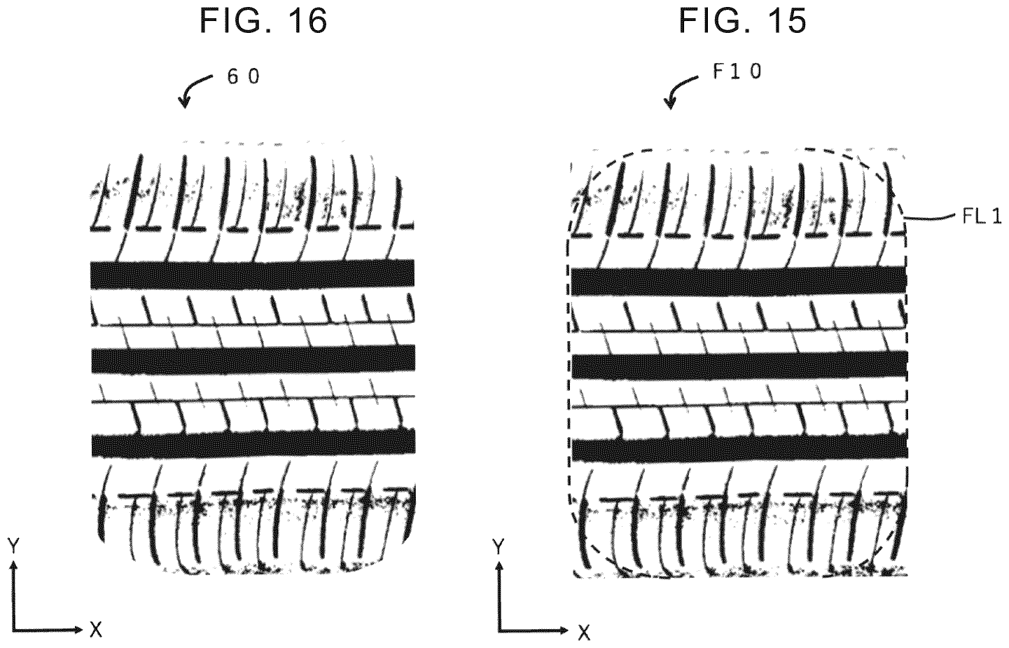

Here, in FIG. 14, the extracted image has a rectangular shape. On the other hand, the four corners of the actual footprint image are rounded. Therefore, as illustrated in FIG. 15, the extraction frame FL1 may be rounded. For example, a quarter of the shorter of the contact patch width L30 and the contact patch length L31 is set to the radius of curvature.

The images extracted by the rounded extraction frame FL1 are illustrated in FIG. 16. The image processing unit 20 outputs the extracted image as the footprint image 60 (S31). For example, the footprint image 60 is displayed on the display unit 16 (see FIG. 2).

In the above-described embodiment, the image captured by the image capturing device 19 is used as the exterior image of the tire 100. Instead of the captured image, 3D by 3D-CAD or the like may be inputted as an exterior image of the tire 100.

What is claimed is:

1. A generating device for a tire footprint image, the generating device comprising a processor, wherein the processor is configured to perform
processing an exterior image of a tire including a curved tread surface into a planar tread surface image,
setting to determine an extraction range of the planar tread surface image, and
extracting part of the planar tread surface image based on the extraction range and outputting the extracted part as a footprint image, and
the processor is configured to
in the setting, determine a contact patch width of the tire and a contact patch length of the tire based on specification data of the tire and vehicle weight data, and
in the setting, determine the extraction range based on the contact patch width and the contact patch length.

2. The generating device according to claim 1, wherein the processor is configured to, in the processing,
obtain a center line of the exterior image of the tire,
divide the exterior image of the tire using the center line as a dividing line,
perform a projective transformation on each of divided images, and
combine the divided images after the projective transformation to generate the planar tread surface image.

3. The generating device according to claim 2, wherein the processor is configured to, in the setting,
generate an extraction frame based on the contact patch width and the contact patch length, and
round the extraction frame.

4. The generating device according to claim 2, wherein the processor is configured to, in the projective transformation, set a vertex for the projective transformation on a tangent line to a boundary edge of the curved tread surface included in the divided images before the projective transformation.

5. The generating device according to claim 1, wherein the processor is equipped with
a contact patch length neural network that uses the specification data of the tire and the vehicle weight data as an input layer and that uses the contact patch length as an output layer, and
a contact patch width neural network that uses the specification data of the tire and the vehicle weight data as an input layer and that uses the contact patch width as an output layer.
